(19) United States
(12) Patent Application Publication
(10) Pub. No.: US 2025/0095420 A1
(43) Pub. Date: Mar. 20, 2025

(54) COMPONENT STATUS ESTIMATION SYSTEM, COMPONENT STATUS ESTIMATION METHODS, AND NON-TRANSITORY RECORDING MEDIUM

(71) Applicant: TOYOTA JIDOSHA KABUSHIKI KAISHA, Toyota-shi Aichi-ken (JP)

(72) Inventor: Takayuki MATSUNO, Nagoya-shi Aichi-ken (JP)

(73) Assignee: TOYOTA JIDOSHA KABUSHIKI KAISHA, Toyota-shi Aichi-ken (JP)

(21) Appl. No.: 18/821,387

(22) Filed: Aug. 30, 2024

(30) Foreign Application Priority Data
Sep. 19, 2023 (JP) 2023-151452

(51) Int. Cl. G07C 5/08; G07C 5/00

(52) U.S. Cl. CPC G07C 5/0808; G07C 5/008; G07C 5/0825; G07C 5/085

(57) ABSTRACT

A component status estimation system includes: a recording unit in which is recorded a component status determination map representing relationships between sizes of input loads that are loads input to a vehicle, input parts, and a status of each part of a constituent component of the vehicle; and a processor, the processor estimating the sizes of the input loads and the input parts based on driving data of the vehicle and estimating the status of each part of the constituent component based on the sizes of the input loads and the input parts it has estimated and the component status determination map.

### CROSS-REFERENCE TO RELATED APPLICATION

This application is based on and claims priority under 35 USC 119 from Japanese Patent Application No. 2023-151452 filed on Sep. 19, 2023, the disclosure of which is incorporated by reference herein.

### BACKGROUND

### Technical Field

The present disclosure relates to a component status estimation system, a component status estimation method, and a non-transitory recording medium.

### Related Art

Japanese Patent Application Laid-open (JP-A) No. H06-286652 discloses a technology where components configuring a portion of a frame member of a vehicle are integrally molded by casting. The components include left and right rear wheel wells.

A vehicle is subjected to various external forces while driving, for example. For that reason, the statuses of some parts of the above components may change due to these external forces.

### SUMMARY

In consideration of the above circumstances, it is an object of the present disclosure to obtain a component status estimation system, a component status estimation method, and a non-transitory recording medium that can estimate the status of each part of a constituent component that changes due to loads input to a vehicle.

A component status estimation system of a first aspect includes: a recording unit in which is recorded a component status determination map representing relationships between sizes of input loads that are loads input to a vehicle, input parts, and a status of each part of a constituent component of the vehicle; and a processor that: estimates the sizes of the input loads and the input parts based on driving data of the vehicle, and that estimates the status of each part of the constituent component based on the sizes of the input loads and the input parts it has estimated and the component status determination map.

In the recording unit of the component status estimation system of the first aspect is recorded the component status determination map representing relationships between sizes of input loads that are loads input to the vehicle, the input parts, and the status of each part of the constituent component of the vehicle. Moreover, the component status estimation system includes the processor that estimates the sizes of the input loads and the input parts based on the driving data of the vehicle. Moreover, the processor of the component status estimation system estimates the status of each part of the constituent component based on the sizes of the input loads and the input parts it has estimated and the component status determination map. Consequently, the component status estimation system of the first aspect can estimate the status of each part of the constituent component that changes due to loads input to the vehicle.

A component status estimation system of a second aspect is the first aspect, wherein the constituent component is an integrally molded product manufactured by casting.

In the second aspect, the constituent component is an integrally molded product manufactured by casting. Usually, the ductility of the material configuring an integrally molded product manufactured by casting is low. For that reason, the component status estimation system of the second aspect can estimate the status of each part of the constituent component that is an integrally molded product manufacturing by casting.

A component status estimation system of a third aspect is the second aspect, wherein the constituent component is at least one of a front frame member or a rear frame member that are frame members of the vehicle.

When the vehicle sustains an impact, the statuses of the front frame member and the rear frame member tend to change. For that reason, the component status estimation system of the third aspect can estimate changes in status that have occurred in any part of the front frame member and the rear frame member when, for example, the vehicle sustains an impact.

A component status estimation system of a fourth aspect is the first aspect or the second aspect, wherein the system includes an alert device that issues an alert to an occupant of the vehicle when the processor estimates that the status of at least one of the parts of the constituent component is a predetermined status.

In the fourth aspect, the alert device issues an alert to the occupant of the vehicle when the processor estimates that the status of at least one of the parts of the constituent component is a predetermined status. For that reason, the occupant can then take action such as requesting an inspection of the vehicle from an auto repair and maintenance shop.

A component status estimation system of a fifth aspect is the first aspect or the second aspect, wherein the processor estimates the sizes of the input loads and the input parts based on the driving data and a load estimation map representing relationships between the driving data and the input loads input to the parts of the constituent component.

According to the fifth aspect, the sizes of the input loads and the input parts can be estimated with high precision.

A component status estimation system of a sixth aspect is the first aspect or the second aspect, wherein the system includes an information recording unit in which is recorded information relating to the status of each part of the constituent component estimated by the processor.

According to the sixth aspect, a technician at an auto repair and maintenance shop, for example, can accurately and easily apprehend the status of each constituent component by acquiring the information recorded in the information recording unit.

A component status estimation system of a seventh aspect is the first aspect or the second aspect, wherein the system includes a wireless transmission unit that can wirelessly send information relating to the status of each part of the constituent component estimated by the processor.

According to the seventh aspect, for example a technician at an auto repair and maintenance shop in which is installed an external server that acquires the information sent from the wireless transmission unit can accurately and easily apprehend the status of each constituent component.

A component status estimation system of an eighth aspect is the first aspect or the second aspect, wherein the constituent component is a frame member of the vehicle.

According to the eighth aspect, the status of each part of the frame member that changes due to loads input to the vehicle can be estimated.

A component status estimation system of a ninth aspect is the first aspect or the second aspect, wherein the processor estimates the sizes of the input loads and the input parts based on the driving data and a load estimation map representing relationships between the driving data and the input loads input to the parts of the constituent component, and the constituent component is a frame member of the vehicle.

According to the ninth aspect, the constituent component is a frame member of the vehicle, so the load estimation map can be created using computer-aided engineering (CAE). For that reason, compared with a case where the load estimation map is created based on results of actual experiments, the load estimation map can be easily created.

A component status estimation system of a tenth aspect is the ninth aspect, wherein the frame member is a rear frame member that is a portion of the frame member of the vehicle, and the rear frame member includes, as the parts, left and right rear wheel wells and a rear crossmember that interconnects the left and right rear wheel wells.

According to the tenth aspect, the statuses of the left and right rear wheel wells and the rear crossmember that change due to loads input to the vehicle can be estimated.

A component status estimation system of an eleventh aspect is the tenth aspect, wherein at least one of the left and right rear wheel wells has a plurality of the parts.

According to the eleventh aspect, the status of each part of at least one of the rear wheel wells that changes due to loads input to the vehicle can be estimated.

A component status estimation system of a twelfth aspect is the tenth aspect or the eleventh aspect, wherein the rear crossmember has a plurality of the parts.

According to the twelfth aspect, the status of each part of the rear crossmember that changes due to loads input to the vehicle can be estimated.

A component status estimation system of a thirteenth aspect is the twelfth aspect, wherein the frame member is a front frame member that is a portion of the frame member of the vehicle, and the front frame member includes, as the parts, left and right front wheel wells and a front crossmember that interconnects the left and right front wheel wells.

According to the thirteenth aspect, the statuses of the left and right front wheel wells and the front crossmember that change due to loads input to the vehicle can be estimated.

A component status estimation system of a fourteenth aspect is the thirteenth aspect, wherein at least one of the left and right front wheel wells has a plurality of the parts.

According to the fourteenth aspect, the status of each part of at least one of the front wheel wells that changes due to loads input to the vehicle can be estimated.

A component status estimation system of a fifteenth aspect is the thirteenth aspect or the fourteenth aspect, wherein the front crossmember has a plurality of the parts.

According to the fifteenth aspect, the status of each part of the front crossmember that changes due to loads input to the vehicle can be estimated.

A component status estimation system of a sixteenth aspect is the first aspect or the second aspect, wherein the processor estimates the sizes of the input loads and the input parts in a case in which it is determined that a predetermined specific condition is met based on the driving data.

According to the sixteenth aspect, the processor estimates the sizes of the input loads and the input parts only when the specific condition is met. For that reason, compared with a case where the processor estimates the sizes of the input loads and the input parts regardless of whether the specific condition is met, the computational load of the component status estimation system is smaller.

A component status estimation system of a seventh aspect is the sixteenth aspect, wherein it is determined that the specific condition is met when a detection value of an acceleration sensor provided at the vehicle becomes equal to or greater than a predetermined value, when a detection value of a yaw rate sensor provided at the vehicle becomes equal to or greater than a predetermined value, when a shift position sensor provided at the vehicle detects that a shift position is in a P range or an N range and an acceleration of a magnitude equal to or greater than a predetermined value is detected by the acceleration sensor, or when the shift position sensor detects that the shift position is in a 1st range, a 2nd range, a D range, or an R range and an acceleration of a magnitude equal to or greater than a predetermined value that is in a direction different from a traveling direction of the vehicle is detected by the acceleration sensor.

According to the seventeenth aspect, whether the specific condition is met can be determined with high precision.

A component status estimation system of an eighteenth aspect is the sixteenth aspect, wherein it is determined that the specific condition is met when a following vehicle is driving directly behind the vehicle and a size of an image representing the following vehicle and being displayed on a display provided at the vehicle becomes equal to or greater than a predetermined value.

According to the eighteenth aspect, whether the specific condition is met can be determined with high precision.

A component status estimation method of a nineteenth aspect is a method in which a processor applies, to a component status determination map representing relationships between sizes of inputs loads that are loads input to a vehicle, input parts, and a status of each part of a constituent component of the vehicle, the sizes of the input loads and the input parts estimated based on driving data of the vehicle to thereby estimate the status of each part of the constituent component.

A non-transitory recording medium of a twentieth aspect stores a program executable by a computer to execute a process, the process including: applying, to a component status determination map representing relationships between sizes of inputs loads that are loads input to a vehicle, input parts, and a status of each part of a constituent component of the vehicle, the sizes of the input loads and the input parts estimated based on driving data of the vehicle to thereby estimate the status of each part of the constituent component.

As described above, the component status estimation system, the component status estimation method, and the non-transitory recording medium pertaining to the present disclosure have the effect that they can estimate the status of each part of a constituent component that changes due to loads input to a vehicle.

### BRIEF DESCRIPTION OF THE DRAWINGS

An exemplary embodiment of the present disclosure will be described in detail based on the following figures, wherein:

FIG. 1 is a schematic side view of a vehicle in which a component status estimation system pertaining to the embodiment is installed;

FIG. 2 is a schematic perspective view of a frame member of the vehicle shown in FIG. 1;

FIG. 3 is a control block diagram of an ECU installed in the vehicle;

FIG. 4 is a functional block diagram of the ECU;

FIG. 5 is a cross-sectional view taken along arrowed line 5-5 of FIG. 2;

FIG. 6 is a graph showing wheel velocity detection values that are one set of driving data;

FIG. 7 is a graph showing wheel velocity differential values that are one set of driving data;

FIG. 8 is a graph showing steering angle detection values that are one set of driving data;

FIG. 9 is a graph showing acceleration detection values that are one set of driving data;

FIG. 10 is a graph showing yaw rate detection values that are one set of driving data;

FIG. 11 is a graph showing shift position detection values that are one set of driving data;

FIG. 12 is a graph showing brake switch detection values that are one set of driving data;

FIG. 13 is a drawing showing imaging data acquired by a rear camera that are one set of driving data;

FIG. 14 is a load estimation map showing relationships between driving data and loads input to each frame member;

FIG. 15 is a drawing showing a component status determination map; and

FIG. 16 is a flowchart showing processes executed by a CPU of the ECU.

### DETAILED DESCRIPTION

A component status estimation system, a component status estimation method, and a non-transitory recording medium pertaining to the disclosure will be described below with reference to the attached drawings. Arrow FR appropriately shown in the drawings indicates a forward direction in a vehicle front and rear direction, arrow LH indicates a leftward direction in a vehicle left and right direction, and arrow UP indicates an upward direction in a vehicle up and down direction.

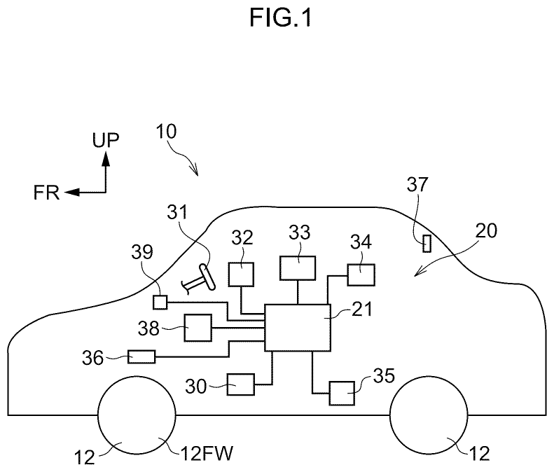

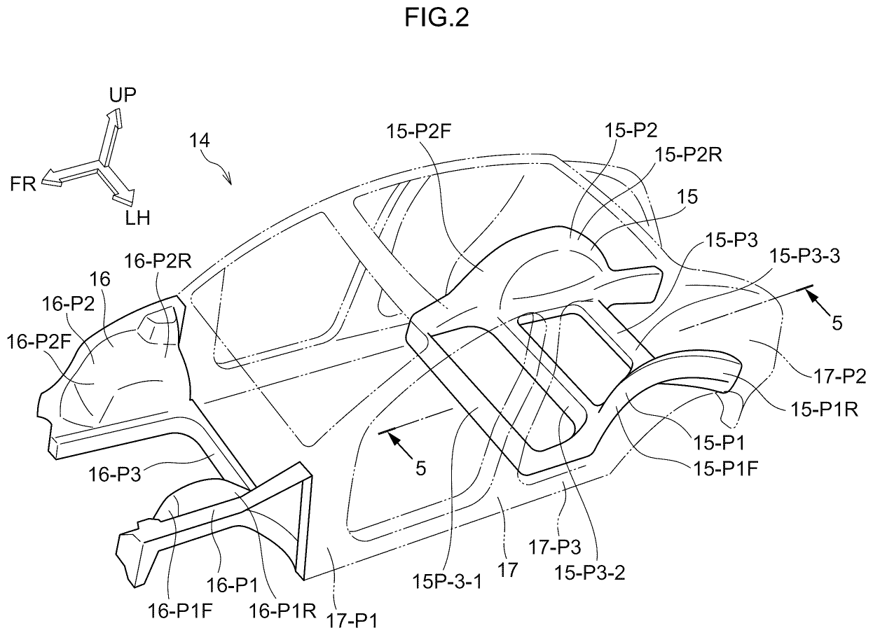

As shown in FIG. 1 and FIG. 2, a vehicle 10 in which a component status estimation system 20 is installed includes four wheels 12 and a frame member 14.

As shown in FIG. 2, the frame member 14 includes a rear frame member 15 that configures a rear portion of the frame member 14, a front frame member 16 that configures a front portion of the frame member 14, and a main frame member 17 that interconnects the rear frame member 15 and the front frame member 16 and is larger than the rear frame member 15 and the front frame member 16. The rear frame member 15, the front frame member 16, and the main frame member 17 of the present embodiment are a large aluminum die cast product. In other words, the rear frame member 15, the front frame member 16, and the main frame member 17 are an integrally molded product made of aluminum and manufactured by casting. It will be noted that the material configuring the frame member 14 may be a material other than aluminum. The rear frame member 15 includes a first part 15-P1 that is a part on the left side thereof, a second part 15-P2 that is a part on the right side thereof, and a third part 15-P3 that is a remaining part. The first part 15-P1 and the second part 15-P2 are rear wheel wells (rear wheel arches). The third part 15-P3 includes three rear crossmembers 15-P3-1, 15-P3-2, 15-P3-3 lined up in the front and rear direction. The rear crossmembers 15-P3-1, 15-P3-2, 15-P3-3 extend in the left and right direction and interconnect the first part 15-P1 and the second part 15-P2 in three places. The front frame member 16 includes a first part 16-P1 that is a part on the left side thereof, a second part 16-P2 that is a part on the right side thereof, and a third part 16-P3 that is a remaining part. The first part 16-P1 and the second part 16-P2 are front wheel wells (front wheel arches). The third part 16-P3 is a front crossmember that extends in the left and right direction and interconnects rear end portions of the first part 16-P1 and the second part 16-P2. The main frame member 17 includes a first part 17-P1 that is a part on the front side thereof, a second part 17-P2 that is a part on the rear side thereof, and a third part 17-P3 that is a remaining part.

As shown in FIG. 1, the vehicle 10 includes an electronic control unit (ECU) 21, a wheel velocity sensor 30, a steering wheel 31, a steering angle sensor 32, an acceleration sensor 33, a yaw rate sensor 34, a shift position sensor 35, a brake switch 36, a rear camera 37, a display (alert device) 38, and an ignition switch 39. Two front wheels 12FW are steered wheels. For that reason, when the steering angle of the steering wheel 31 changes, the steered angle of the left and right front wheels 12FW changes. The wheel velocity sensor 30, the steering angle sensor 32, the acceleration sensor 33, the yaw rate sensor 34, the shift position sensor 35, the brake switch 36, the rear camera 37, the display 38, and the ignition switch 39 are connected to the ECU 21. When the ignition switch 39 is off, the drive source of the vehicle 10 is inoperable, and when the ignition switch 39 is on, the drive source is operable. It will be noted that the drive source includes at least one of an engine or an electric motor for example. For that reason, the “ignition switch 39” of the present specification includes an ignition switch operated by a key and other kinds of switches. The other kinds of switches include a push-start button for example.

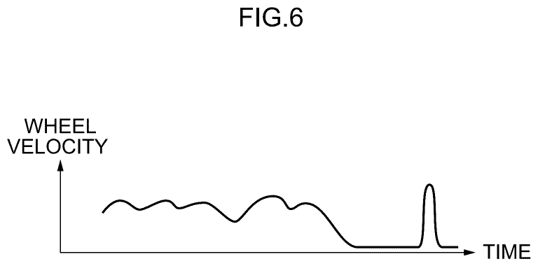

When the ignition switch 39 is on, as shown in FIG. 6, every time a predetermined amount of time elapses, the wheel velocity sensor 30 acquires the wheel velocity of the vehicle 10 and sends the acquired wheel velocity to the ECU 21.

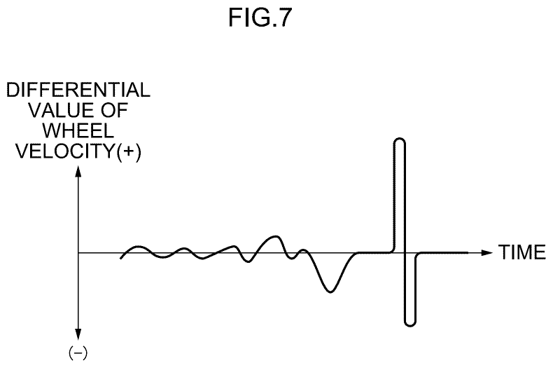

Moreover, when the ignition switch 39 is on, as shown in FIG. 7, every time a predetermined amount of time elapses, a later-described CPU 22 acquires a differential value of the detection value of the wheel velocity sensor 30.

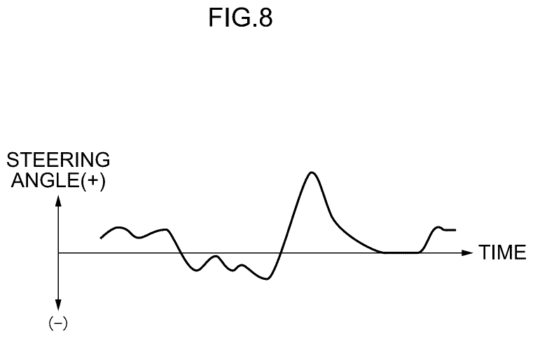

When the ignition switch 39 is on, as shown in FIG. 8, every time a predetermined amount of time elapses, the steering angle sensor 32 acquires the steering angle, which is the angle of rotation of the steering wheel 31, and sends the acquired steering angle to the ECU 21. It will be noted that + (plus) on the vertical axis of the graph in FIG. 8 represents a steering angle in a clockwise direction and − (minus) represents a steering angle in a counterclockwise direction.

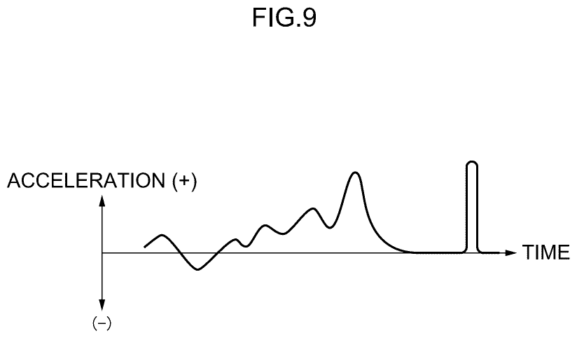

When the ignition switch 39 is on, as shown in FIG. 9, every time a predetermined amount of time elapses, the acceleration sensor 33 acquires the acceleration in the up and down direction, the left and right direction, and the front and rear direction occurring in the vehicle 10 and sends the acquired acceleration to the ECU 21. It will be noted that + (plus) on the vertical axis of the graph in FIG. 9 represents positive acceleration and − (minus) represents negative acceleration (deceleration).

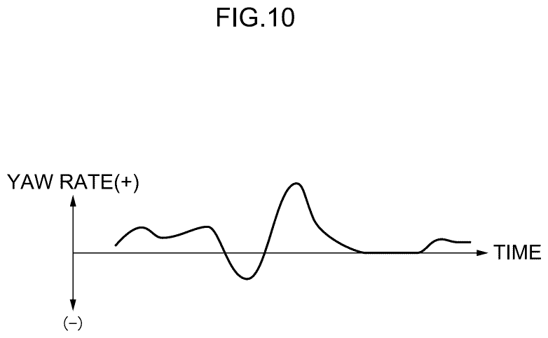

When the ignition switch 39 is on, as shown in FIG. 10, every time a predetermined amount of time elapses, the yaw rate sensor 34 acquires the yaw rate of the vehicle 10 and sends the acquired yaw rate to the ECU 21. It will be noted that + (plus) on the vertical axis of the graph in FIG. 10 represents a yaw rate in a clockwise direction as seen in plan view and − (minus) represents a yaw rate in a counterclockwise direction as seen in plan view.

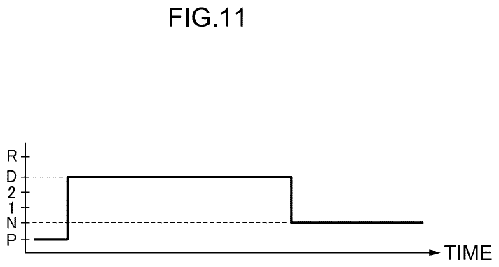

When the ignition switch 39 is on, as shown in FIG. 11, every time a predetermined amount of time elapses, the shift position sensor 35 acquires the shift position of a shift lever (not shown in the drawings) and sends the acquired shift position to the ECU 21. The shift positions of the shift lever in the present embodiment include a P range, an N range, a 1st range, a 2nd range, a D range, and an R range.

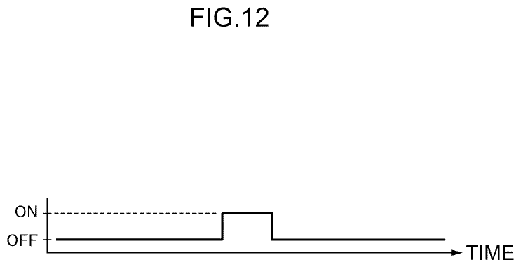

The brake switch 36, as shown in FIG. 12, switches on when a brake pedal (not shown in the drawings) is depressed an operation amount equal to or greater than a predetermined value and sends a detection signal to the ECU 21. When the operation amount of the brake pedal is less than the predetermined value, the brake switch 36 switches off (does not output a detection signal). When the brake switch 36 outputs the detection signal, brake devices (not shown in the drawings) provided in the vehicle 10 are activated by the control of the ECU 21.

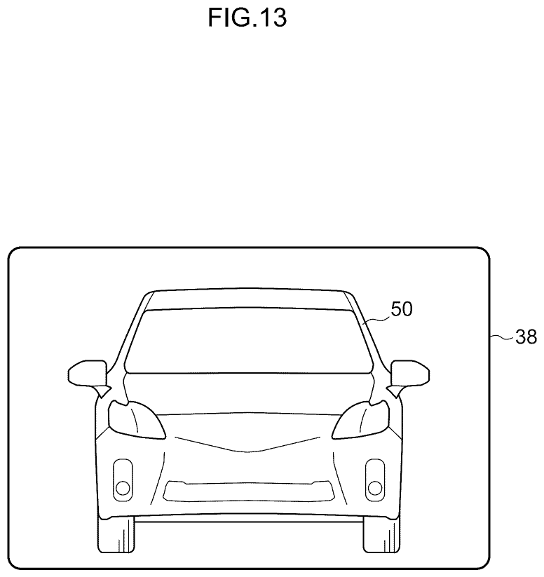

When the ignition switch 39 is on, as shown in FIG. 13, every time a predetermined amount of time elapses, the rear camera 37 images a subject positioned in back of the vehicle 10 and sends the acquired imaging data to the ECU 21.

The display 38 is provided in an instrument panel for example. The display 38 can display various images. For example, as shown in FIG. 13, the display 38 can display an image based on the imaging data acquired by the rear camera 37. In FIG. 13, an image representing a following vehicle 50 driving directly behind the vehicle 10 is displayed on the display 38. Furthermore, the display 38 can display later-described alert information.

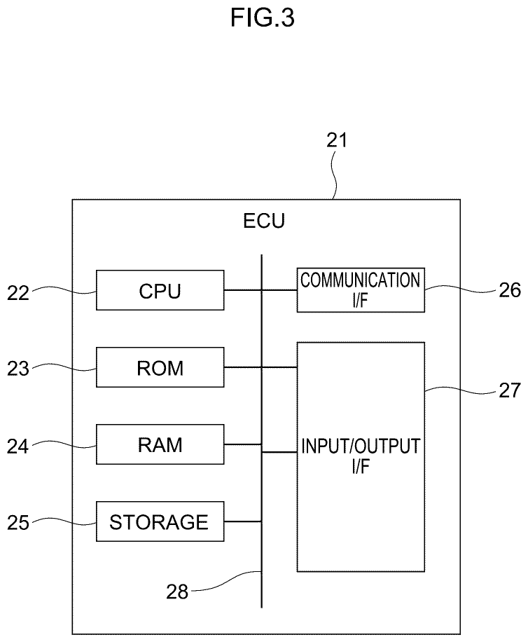

As shown in FIG. 3, the ECU 21 is configured to include a central processing unit (CPU) 22, a read-only memory (ROM) 23, a random-access memory (RAM) 24, a storage (information recording unit) 25, a communication interface (I/F) (wireless transmission unit) 26, and an input/output interface (I/F) 27. The CPU 22, the ROM 23, the RAM 24, the storage 25, the communication I/F 26, and the input/output I/F 27 are communicably connected to each other via a bus 28. The ECU 21 can acquire information relating to the time and date from a timer (not shown in the drawings).

The CPU 22 is a central arithmetic processing unit, executes various types of programs, and controls each part. That is, the CPU 22 reads programs from the ROM 23 or the storage 25 and executes the programs using the RAM 24 as a workspace. The CPU 22 controls each configuration and performs various types of arithmetic processing (information processing) in accordance with the programs recorded in the ROM 23 or the storage 25.

The ROM (a non-transitory recording medium) 23 stores various types of programs and various types of data. The RAM 24 temporarily stores programs or data as a workspace. The storage (a non-transitory recording medium) 25 is configured by a storage device such as a hard disk drive (HDD) or a solid-state drive (SSD) and stores various types of programs and various types of data. The communication I/F 26 is an interface that can communicate with devices positioned outside the vehicle 10. For example, the communication I/F 26 can wirelessly communicate with an external server (not shown in the drawings). The communication I/F 26 uses a communication standard such as Bluetooth (registered trademark) or Wi-Fi (registered trademark). Moreover, the communication I/F 26 can communicate via an external bus with an ECU different from the ECU 21 provided in the vehicle 10.

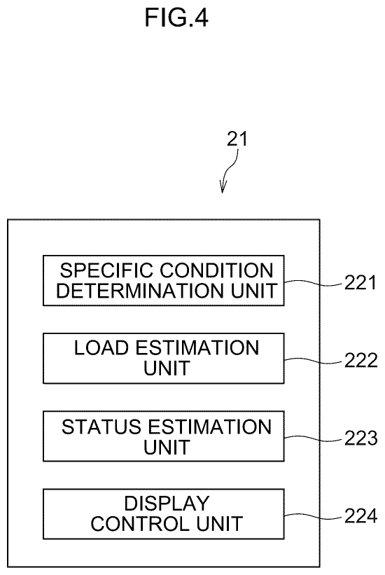

As shown in FIG. 4, the ECU 21 (processor) includes, as functional configurations, a specific condition determination unit 221, a load estimation unit 222, a status estimation unit 223, and a display control unit 224. The specific condition determination unit 221, the load estimation unit 222, the status estimation unit 223, and the display control unit 224 are realized by the CPU 22 of the ECU 21 reading and executing programs stored in the ROM 23.

The specific condition determination unit 221 utilizes the above-described sets of driving data shown in FIG. 6 to FIG. 13 to determine whether a specific condition is met. In a case where it is estimated that an external force with a low probability of being input has been input to the vehicle 10 during normal driving, the specific condition is met. For example, the specific condition is met in a case where the following vehicle 50 impacts the vehicle 10 or a case where the front wheels 12 of the vehicle 10 impact a curbstone of a road. For example, the specific condition determination unit 221 determines that the specific condition is met due to the following vehicle 50 impacting the vehicle 10 when the size of the image representing the following vehicle 50 and being displayed on the display 38 becomes equal to or greater than a predetermined value and the detection value of the acceleration sensor 33 becomes equal to or greater than a predetermined value. It will be noted that the specific condition determination unit 221 may determine that the specific condition is met due to the following vehicle 50 impacting the vehicle 10 regardless of the detection value of the acceleration sensor 33 in a case where the size of the image representing the following vehicle 50 and being displayed on the display 38 becomes equal to or greater than a predetermined value. Furthermore, the specific condition determination unit 221 may determine that the specific condition is met when the detection value of the acceleration sensor 33 becomes equal to or greater than a predetermined value or when the detection value of the yaw rate sensor 34 becomes equal to or greater than a predetermined value. Furthermore, the specific condition determination unit 221 may determine that the specific condition is met when the shift position sensor 35 detects that the shift position is in the P range or the N range and an acceleration of a magnitude equal to or greater than a predetermined value is detected by the acceleration sensor 33. Furthermore, the specific condition determination unit 221 may determine that the specific condition is met when the shift position sensor 35 detects that the shift position is in the 1st range, the 2nd range, the D range, or the R range and an acceleration of a magnitude equal to or greater than a predetermined value that is in a direction different from a traveling direction of the vehicle 10 represented by the shift position sensor 35 is detected by the acceleration sensor 33. In this way, by utilizing at least one of the image displayed on the display 38, the detection value of the acceleration sensor 33, the detection value of the yaw rate sensor 34, and the detection value of the shift position sensor 35, whether the specific condition is met can be determined with high precision.

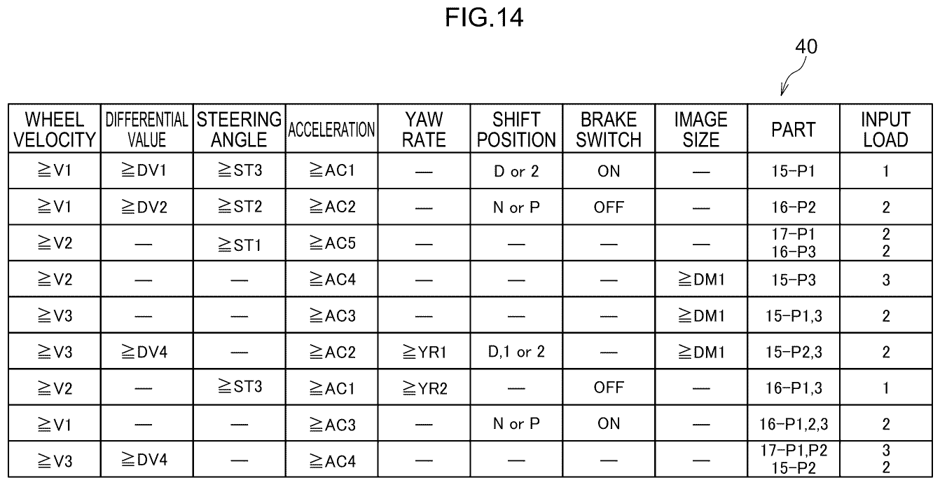

The load estimation unit 222 estimates loads (input loads) input to each part of the rear frame member 15, the front frame member 16, and the main frame member 17 based on the above-described sets of driving data and a load estimation map 40 shown in FIG. 14 and recorded in the ROM 23. The load estimation map 40 is a map representing relationships between the above-described sets of driving data and input loads input to each part of the rear frame member 15, the front frame member 16, and the main frame member 17. It will be noted that the load estimation map 40 can be created using computer-aided engineering (CAE) for example. However, the load estimation map 40 may be created based on results of experiments in which loads are actually applied to a vehicle. More specifically, the load estimation unit 222 estimates sizes of input loads and input parts in the rear frame member 15, the front frame member 16, and the main frame member 17. For example, in a case where the wheel velocity is equal to or greater than a predetermined value V2, the acceleration is equal to or greater than a predetermined value AC4, and the size of the following vehicle 50 included in the imaging data acquired by the rear camera 37 is equal to or greater than a predetermined value DM1, the load estimation map 40 specifies that it is estimated that an input load of “3” has been input to the third part 15-P3 of the rear frame member 15. In other words, in this case, it is estimated that an input load of “3” has been input to the third part 15-P3 due to the following vehicle 50 impacting the rear portion of the vehicle 10. Furthermore, in a case where the wheel velocity is equal to or greater than a predetermined value V3 and the differential value is equal to or greater than DV4, the load estimation map 40 specifies that it is estimated that an input load of “3” has been input to the first part 17-P1 and the second part 17-P2 and that an input load of “2” has been input to the second part 15-P2. The load estimation map 40 specifies the sizes of the input loads in three stages. An input load of “2” is greater than an input load of “1”, and an input load of “3” is greater than an input load of “2.” The “−” marks in the load estimation map 40 indicate that information relating to that item is unnecessary. The load estimation unit 222 estimates the input loads for each part of the rear frame member 15, the front frame member 16, and the main frame member 17 based on the above-described sets of driving data and the load estimation map 40, so it can estimate the parts to which the input loads have been applied and the sizes of the input loads with high precision.

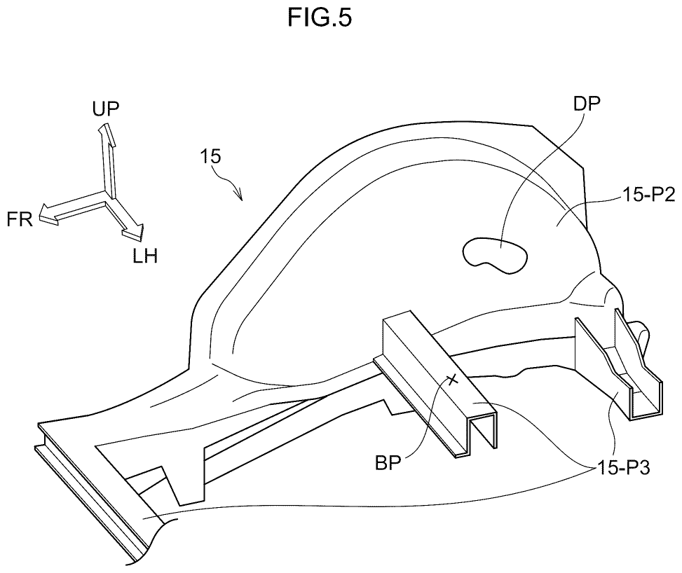

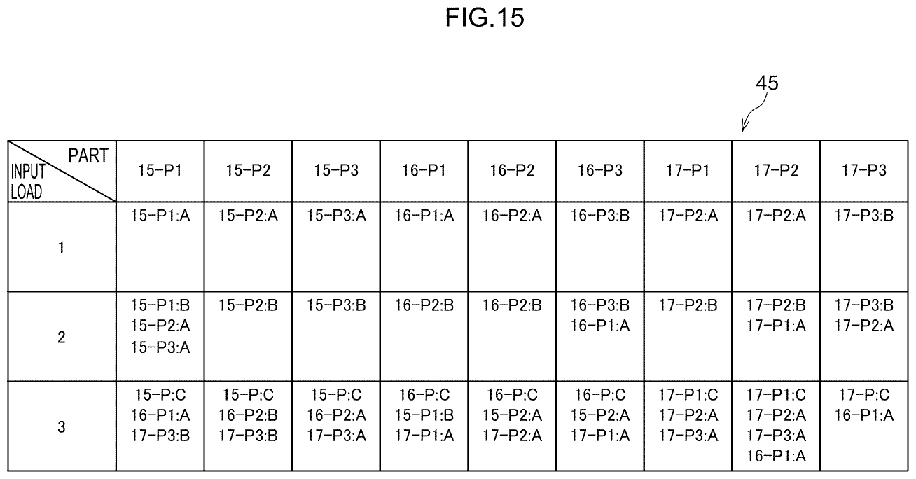

The status estimation unit 223 estimates a status of each part of each frame member based on the sizes of the input loads and the input parts estimated by the load estimation unit 222 and a component status determination map 45 shown in FIG. 15 and recorded in the ROM 23. The component status determination map 45 is a map representing relationships between the sizes of the input loads that are loads input to the vehicle, the input parts, and the status of each part of a constituent component of the vehicle. “Status of each part of a constituent component of the vehicle” refers to the status of each part in an integrally provided constituent component of the vehicle. “Part” refers to parts defined by sectioning, into two or more parts, the integrally provided constituent component of the vehicle. Status A shown in FIG. 15 is a status where there is the risk of deformation, status B is a status where there is the risk of a crack, and status C is a status where there is the risk of a break. It will be noted that in FIG. 15, for the sake of convenience, status A is notated as “A,” status B is notated as “B,” and status C is notated as “C.” Furthermore, in FIG. 15, “15-P” means the entire rear frame member 15, “16-P” means the entire front frame member 16, and “17-P” means the entire main frame member 17. For example, in a case where an input load of “1” has been applied to the second part 15-P2 of the rear frame member 15, the component status determination map 45 specifies that the status of the second part 15-P2 become “A.” That is, in this case, as shown in FIG. 5, there is the risk that a deformed part DP has occurred in the second part 15-P2. Furthermore, in a case where an input load of “1” has been applied to the first part 16-P1 of the front frame member 16, the component status determination map 45 specifies that the status of the first part 16-P1 become “A.” Furthermore, in a case where an input load of “2” has been applied to the third part 15-P3 of the rear frame member 15, the component status determination map 45 specifies that the status of the third part 15-P3 become “B.” That is, in this case, as shown in FIG. 5, there is the risk that a crack BP has formed in the third part 15-P3. Furthermore, in a case where an input load of “3” has been applied to the second part 17-P2 of the main frame member 17, the component status determination map 45 specifies that the status of the first part 17-P1 become “C,” the status of the second part 17-P2 become “A,” the status of the third part 17-P3 become “A,” and the status of the first part 16-P1 become “A.”

Suppose a case where, for example, an input load of “3” has been applied to the third part 15-P3 of the rear frame member 15 due to the following vehicle 50 impacting the rear portion of the vehicle 10. In this case, the status estimation unit 223 estimates, based on the component status determination map 45, that the entire rear frame member 15 will be status C, the second part 16-P2 will be status A, and the third part 17-P3 will be status A.

The display control unit 224 controls the display 38. For example, the display control unit 224 causes the display 38 to display an image based on the imaging data acquired by the rear camera 37. Furthermore, when the status estimation unit 223 estimates that any part of the rear frame member 15, the front frame member 16, and the main frame member 17 has become at least one status (a predetermined status) of status A, B, or C, the display control unit 224 causes the display 38 to display alert information. The alert information in a case where, for example, it has been estimated that a crack has formed in the first part 16-P1 may be the text, “The first part 16-P1 of the front frame member 16 may have a crack.” Furthermore, the alert information in a case where, for example, any part of the rear frame member 15 is at least one of status A, B, or C may be the text, “The rear frame member 15 may have a problem, so have it inspected at an auto repair and maintenance shop soon.”

Of the configurations described above, the ECU 21, the wheel velocity sensor 30, the steering angle sensor 32, the acceleration sensor 33, the yaw rate sensor 34, the shift position sensor 35, the brake switch 36, the rear camera 37, the display 38, the load estimation map 40, and the component status determination map 45 are constituent elements of the component status estimation system 20.

### (Action and Effects)

Next, the action and effects of the embodiment will be described.

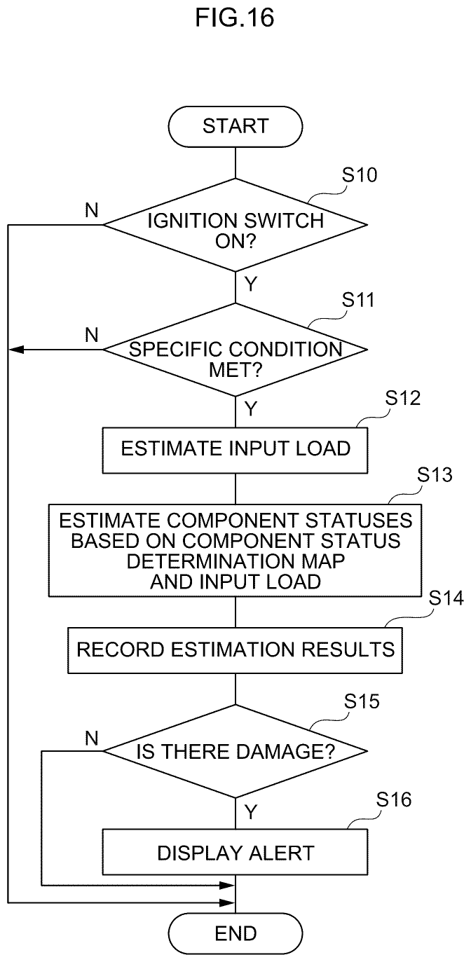

A flow of processes performed by the CPU 22 of the ECU 21 of the vehicle 10 will be described using the flowchart of FIG. 16. The CPU 22 repeatedly executes the processes in the flowchart of FIG. 16 every time a predetermined amount of time elapses.

First, in step S10 (hereinafter the word “step” will be omitted), the CPU 22 determines whether the ignition switch 39 is on.

When the determination in S10 is Yes, the CPU 22 proceeds to S11 and determines whether the specific condition is met.

When the determination in S11 is Yes, the CPU 22 proceeds to S12 and estimates, based on the sets of driving data and the load estimation map 40, the size of the input load and the input part(s) in the rear frame member 15, the front frame member 16, and the main frame member 17.

When the CPU 22 finishes the process of S12, it proceeds to S13 and estimates the statuses of the rear frame member 15, the front frame member 16, and the main frame member 17 based on the information relating to the size of the input load and the input part(s) acquired in S12 and the component status determination map 45.

When the CPU 22 finishes the process of S13, it proceeds to S14 and records in the ROM 23 or the storage 25 the information relating to the statuses of the rear frame member 15, the front frame member 16, and the main frame member 17 acquired in S13.

When the CPU 22 finishes the process of S14, it proceeds to S15. In S15, the CPU 22 determines whether it was estimated in S13 that at least one of the rear frame member 15, the front frame member 16, or the main frame member 17 is at least one of status A, status B, or status C.

When the determination in S15 is Yes, the CPU 22 proceeds to S16 and causes the display 38 to display the alert information.

When the determination in S10, S11, and S15 is No, or when the process of S16 is finished, the CPU 22 temporarily ends the processes in the flowchart of FIG. 16.

As described above, the component status estimation system 20 of the present embodiment estimates the sizes of the input loads and the input parts based on the driving data of the vehicle 10 and estimates the status of each part of the rear frame member 15, the front frame member 16, and the main frame member 17 based on the sizes of the input loads and the input parts that have been estimated and the component status determination map 45. That is, the component status estimation system 20 can estimate the status of each part of constituent components (the rear frame member 15, the front frame member 16, and the main frame member 17) that changes due to loads input to the vehicle 10. For that reason, it is easy for a technician at an auto repair and maintenance shop receiving the information relating to the status of each part of each constituent component from the component status estimation system 20 to accurately and easily apprehend the status of each constituent component. For that reason, the technician can quickly and easily execute work to repair each constituent component or work to replace each constituent component with a new constituent component.

Moreover, the rear frame member 15, the front frame member 16, and the main frame member 17, which are constituent components whose statuses are estimated by the component status estimation system 20, are an integrally molded product manufactured by casting. Usually, the ductility of the material configuring an integrally molded product manufactured by casting is low. For that reason, the rear frame member 15, the front frame member 16, and the main frame member 17 are likely to crack when they are affected by an input load. The component status estimation system 20 can estimate that a crack that is difficult for a technician at an auto repair and maintenance shop to visually apprehend has formed in any part of at least one of the rear frame member 15, the front frame member 16, or the rear frame member 17. For that reason, it is easy for a technician at an auto repair and maintenance shop receiving the information relating to the crack acquired by the component status estimation system 20 to apprehend the crack that has formed in at least one of the rear frame member 15, the front frame member 16, or the main frame member 17.

Moreover, the specific condition is met when, for example, the front portion of the vehicle 10 impacts an obstacle, the following vehicle 50 impacts the rear portion of the vehicle 10, or any of the tires 12 impacts a curbstone. For that reason, when the specific condition is met, at least one of the rear frame member 15 or the front frame member 16 is likely to become at least one of status A, status B, or status C. When this kind of situation occurs in the vehicle 10 for example, the component status estimation system 20 of the present embodiment can estimate the change in status that has occurred in at least one of the rear frame member 15 or the front frame member 16.

Moreover, when the status estimation unit 223 estimates that any part of the rear frame member 15, the front frame member 16, and the main frame member 17 has become at least one of status A, B, or C, the display 38 displays the alert information. For that reason, an occupant apprehending the alert information can then take action such as requesting an inspection of the vehicle 10 from an auto repair and maintenance shop.

The constituent component is the frame member of the vehicle 10 (the rear frame member 15, the front frame member 16, and the rear frame member 17), so the load estimation map 40 can be created using CAE. For that reason, compared with a case where the load estimation map 40 is created based on results of actual experiments, the load estimation map 40 can be easily created.

Furthermore, the load estimation unit 222 estimates the sizes of the input loads and the input parts only when the specific condition is met. For that reason, compared with a case where the load estimation unit 222 estimates the sizes of the input loads and the input parts regardless of whether the specific condition is met, the computational load of the CPU 22 is smaller.

The component status estimation system 20, the component status estimation method, and the non-transitory recording medium pertaining to the embodiment have been described above, but the component status estimation system 20, the component status estimation method, and the non-transitory recording medium can be changed in design as appropriate without departing from the spirit of the disclosure.

In the embodiment, the rear frame member 15, the front frame member 16, and the main frame member 17 are each specified by three parts, but the number of parts configuring each of the rear frame member 15, the front frame member 16, and the main frame member 17 may be any number as long as it is plural. For example, the rear crossmembers 15-P3-1, 15-P3-2, 15-P3-3 of the rear frame member 15 may be mutually different parts. Furthermore, at least one of the first part 15-P1 or the second part 15-P2 may include plural parts. For example, as shown in FIG. 2, the first part 15-P1 and the second part 15-P2 may include front portions 15-P1F, 15-P2F and rear portions 15-P1R, 15-P2R. Likewise, the first part 16-P1 and the second part 16-P2 may include front portions 16-P1F, 16-P2F and rear portions 16-P1R, 16-P2R. Furthermore, at least one of the rear crossmembers 15-P3-1, 15-P3-2, 15-P3-3 or the front crossmember (third part) 16-P3 may include plural parts. In a case where the component status estimation system 20 is configured by an aspect of this kind of example modification, positions where deformation, cracks, and breaks have occurred in each frame member can be identified in greater detail.

The rear frame member 15, the front frame member 16, and the main frame member 17 need not be cast products.

The constituent component whose status is estimated by the component status estimation system 20 may be at least one of the rear frame member 15, the front frame member 16, or the main frame member 17.

The constituent component whose status is estimated by the component status estimation system 20 may be a component different from the frame member 14. For example, in a case where the vehicle 10 is a hybrid electric vehicle (HEV), a plug-in hybrid electric vehicle (PHEV), or a battery electric vehicle (BEV), the battery (battery case) for supplying power to the electric motor that is the drive source of the vehicle 10 may be the constituent component.

In the present embodiment, the vehicle 10 is equipped with the specific condition determination unit 221, the load estimation unit 222, the status estimation unit 223, and the display control unit 224. However, an external server wirelessly communicable with the vehicle 10 may be equipped with at least one of the specific condition determination unit 221, the load estimation unit 222, the status estimation unit 223, or the display control unit 224. For example, the external server may have the functions of the specific condition determination unit 221, the load estimation unit 222, the status estimation unit 223, and the display control unit 224 and, based on the driving data received by wireless communication from the vehicle 10, estimate the status occurring in any part of the constituent component and generate the alert information. In this case, the external server wirelessly sends to the vehicle 10 the information relating to the estimated status and the alert information, and the display 38 displays the alert information. Furthermore, for example, the external server may have some of the functions of the specific condition determination unit 221, the load estimation unit 222, the status estimation unit 223, and the display control unit 224, and the vehicle 10 may have the remaining functions. In this case, the external server sends by wireless communication to the vehicle 10 the results of the processing by the functions with which it is equipped.

The component status estimation system may estimate the status of each part of the constituent component of the vehicle 10 based on driving data different from the driving data described above. Such driving data, for example, includes information relating to the accelerator pedal position, information relating to the position of the vehicle 10 received by a global navigation satellite system (GNSS) receiver, information relating to the number of revolutions per unit of time of an internal combustion engine or an electric motor that is the drive source, and imaging data relating to subjects positioned in front or on the sides of the vehicle.

The alert device may be a speaker that can alert the occupant of the alert information by audio. The alert information (notification information) may be sent by wireless communication to a terminal such as a smartphone owned by the occupant, and the terminal may notify the occupant of the alert information (notification information).

For example, the communication I/F 26 may wirelessly send, to an external server provided in an auto repair and maintenance shop or the like, the information relating to the status of each part of the constituent component estimated by the status estimation unit 223. By configuring the component status estimation system 20 in this way, a technician at an auto repair and maintenance shop can easily apprehend the part of the constituent component in which deformation or the like has occurred.

The component status estimation system need not perform the process of S11 in FIG. 16. That is, the component status estimation system may estimate the status of the constituent component regardless of whether the specific condition is met.

The load estimation unit 222 need not estimate the loads (input loads) input to each part of the constituent component based on the load estimation map 40. The load estimation unit 222 may estimate the loads (input loads) input to each part of the constituent component directly or indirectly based on values acquired by multiple sensors (e.g., acceleration sensors and/or load sensors) provided in various parts of the vehicle. It will be noted that the values acquired by the sensors here are included in the “driving data.”

What is claimed is:

1. A component status estimation system comprising:
a recording unit in which is recorded a component status determination map representing relationships between sizes of input loads that are loads input to a vehicle, input parts, and a status of each part of a constituent component of the vehicle; and
a processor that:
estimates the sizes of the input loads and the input parts based on driving data of the vehicle, and
estimates the status of each part of the constituent component based on the sizes of the input loads and the input parts it has estimated and the component status determination map.

2. The component status estimation system of claim 1, wherein the constituent component is an integrally molded product manufactured by casting.

3. The component status estimation system of claim 2, wherein the constituent component is at least one of a front frame member or a rear frame member that are frame members of the vehicle.

4. The component status estimation system of claim 1, wherein the system includes an alert device that issues an alert to an occupant of the vehicle when the processor estimates that the status of at least one of the parts of the constituent component is a predetermined status.

5. The component status estimation system of claim 1, wherein the processor estimates the sizes of the input loads and the input parts based on the driving data and a load estimation map representing relationships between the driving data and the input loads input to the parts of the constituent component.

6. The component status estimation system of claim 1, wherein the system includes an information recording unit in which is recorded information relating to the status of each part of the constituent component estimated by the processor.

7. The component status estimation system of claim 1, wherein the system includes a wireless transmission unit that can wirelessly send information relating to the status of each part of the constituent component estimated by the processor.

8. The component status estimation system of claim 1, wherein the constituent component is a frame member of the vehicle.

9. The component status estimation system of claim 1, wherein:
the processor estimates the sizes of the input loads and the input parts based on the driving data and a load estimation map representing relationships between the driving data and the input loads input to the parts of the constituent component, and
the constituent component is a frame member of the vehicle.

10. The component status estimation system of claim 8, wherein:
the frame member is a rear frame member that is a portion of the frame member of the vehicle, and
the rear frame member includes, as the parts, left and right rear wheel wells and a rear crossmember that interconnects the left and right rear wheel wells.

11. The component status estimation system of claim 10, wherein at least one of the left and right rear wheel wells has a plurality of the parts.

12. The component status estimation system of claim 10, wherein the rear crossmember has a plurality of the parts.

13. The component status estimation system of claim 12, wherein:
the frame member is a front frame member that is a portion of the frame member of the vehicle, and
the front frame member includes, as the parts, left and right front wheel wells and a front crossmember that interconnects the left and right front wheel wells.

14. The component status estimation system of claim 13, wherein at least one of the left and right front wheel wells has a plurality of the parts.

15. The component status estimation system of claim 13, wherein the front crossmember has a plurality of the parts.

16. The component status estimation system of claim 1, wherein the processor estimates the sizes of the input loads and the input parts in a case in which it is determined that a predetermined specific condition is met based on the driving data.

17. The component status estimation system of claim 16, wherein it is determined that the specific condition is met when a detection value of an acceleration sensor provided at the vehicle becomes equal to or greater than a predetermined value, when a detection value of a yaw rate sensor provided at the vehicle becomes equal to or greater than a predetermined value, when a shift position sensor provided at the vehicle detects that a shift position is in a P range or an N range and an acceleration of a magnitude equal to or greater than a predetermined value is detected by the acceleration sensor, or when the shift position sensor detects that the shift position is in a 1st range, a 2nd range, a D range, or an R range and an acceleration of a magnitude equal to or greater than a predetermined value that is in a direction different from a traveling direction of the vehicle is detected by the acceleration sensor.

18. The component status estimation system of claim 16, wherein it is determined that the specific condition is met when a following vehicle is driving directly behind the vehicle and a size of an image representing the following vehicle and being displayed on a display provided at the vehicle becomes equal to or greater than a predetermined value.

19. A component status estimation method in which a processor applies, to a component status determination map representing relationships between sizes of inputs loads that are loads input to a vehicle, input parts, and a status of each part of a constituent component of the vehicle, the sizes of the input loads and the input parts estimated based on driving data of the vehicle to thereby estimate the status of each part of the constituent component.

20. A non-transitory recording medium storing a program executable by a computer to execute a process, the process including:
applying, to a component status determination map representing relationships between sizes of inputs loads that are loads input to a vehicle, input parts, and a status of each part of a constituent component of the vehicle, the sizes of the input loads and the input parts estimated based on driving data of the vehicle to thereby estimate the status of each part of the constituent component.
